(19) United States
(12) Patent Application Publication
(10) Pub. No.: US 2026/0316780 A1
(43) Pub. Date: Oct. 15, 2026

(54) DRIVING ASSISTANCE APPARATUS, DRIVING ASSISTANCE METHOD, AND NON-TRANSITORY COMPUTER-READABLE STORAGE MEDIUM

(71) Applicants: TOYOTA JIDOSHA KABUSHIKI KAISHA, Toyota-shi (JP); DENSO CORPORATION, Kariya-city (JP)

(72) Inventor: Hayato SHIRAI, Tagata-gun (JP)

(73) Assignees: TOYOTA JIDOSHA KABUSHIKI KAISHA, Toyota-shi (JP); DENSO CORPORATION, Kariya-city (JP)

(21) Appl. No.: 19/536,839

(22) Filed: Feb. 11, 2026

(30) Foreign Application Priority Data
Mar. 31, 2025 (JP) 2025-059008

(51) Int. Cl. B60W 50/14; B60W 30/16

(52) U.S. Cl. CPC B60W 50/14; B60W 30/16; B60W 2050/146; B60W 2530/16; B60W 2540/10; B60W 2552/10; B60W 2554/4041; B60W 2720/10; B60W 2754/30

(57) ABSTRACT

A driving assistance apparatus displays, on a display device of a host vehicle, an energy efficiency improvement image for improving energy efficiency of the host vehicle. The driving assistance apparatus displays, as the energy efficiency improvement image, a following recommendation image that recommends the host vehicle to follow behind a recommended following vehicle traveling ahead of the host vehicle and having an air resistance reduction effect, which reduces air resistance acting on the host vehicle, equal to or greater than a predetermined value; and does not display the following recommendation image in response to a non-recommendation condition being satisfied, the non-recommendation condition being a condition that is satisfied when a driving operation for following behind the recommended following vehicle is not recommended.

### TECHNICAL FIELD

The present invention relates to a driving assistance apparatus that displays, on a display device, an energy efficiency improvement image for improving energy efficiency of a host vehicle; a driving assistance method in which a computer mounted on the host vehicle displays the energy efficiency improvement image; and a program that causes the computer mounted on the host vehicle to display the energy efficiency improvement image.

### BACKGROUND

Conventionally, a driving assistance apparatus configured to display, on a display device of a vehicle, an energy efficiency improvement image for improving energy efficiency of the vehicle has been known. For example, a driving assistance apparatus described in Patent Document 1 (hereinafter referred to as a “conventional apparatus”) acquires, for a plurality of preceding vehicles, a potential value that is a maximum value of an air resistance reduction effect expected when a host vehicle follows a preceding vehicle. The conventional apparatus displays, as a driving assistance image corresponding to each of the preceding vehicles, a vehicle icon representing the preceding vehicle and an effect graphic representing a degree of the potential value of each of the preceding vehicles relative to a common maximum effect value among the preceding vehicles.

Patent Document 1: Japanese Patent Application Laid-Open No. 2024-023029

### SUMMARY

When the conventional apparatus displays the driving assistance image described above, the likelihood increases that a driver performs a driving operation for causing the host vehicle to follow behind the preceding vehicle having a high air resistance reduction effect. Such driving operation is referred to as a “following operation”. The following operation includes, for example, an acceleration operation of accelerating the host vehicle to approach the preceding vehicle. The conventional apparatus displays the driving assistance image even in a non-recommended situation in which a collision risk with an object increases when the following operation is performed. Therefore, the conventional apparatus cannot reduce the possibility that the following operation is performed in the non-recommended situation.

The present disclosure has been made in order to address the above-described problems. That is, one of the objects of the present disclosure is to provide a driving assistance apparatus capable of reducing the possibility that the following operation is performed in the non-recommended situation.

A driving assistance apparatus according to the present disclosure (hereinafter, referred to as "the present apparatus") configured to display, on a display device of a host vehicle, an energy efficiency improvement image for improving energy efficiency of the host vehicle.

The driving assistance apparatus is configured to:
display, as the energy efficiency improvement image, a following recommendation image (56) that recommends the host vehicle to follow behind a recommended following vehicle traveling ahead of the host vehicle and having an air resistance reduction effect, which reduces air resistance acting on the host vehicle, equal to or greater than a predetermined value (step 540, step 545); and
not display the following recommendation image in response to a non-recommendation condition being satisfied ("No" at step 525, "Yes" at step 530), the non-recommendation condition being a condition that is satisfied when a driving operation for following behind the recommended following vehicle is not recommended.

According to the present apparatus, the following recommendation image is not displayed when the non-recommendation condition is satisfied. Accordingly, the present apparatus can reduce a possibility that a driving operation for following behind the recommended following vehicle (a following operation) is performed when the non-recommendation condition is satisfied.

In one aspect of the present apparatus,

the driving assistance apparatus is configured to:
determine that the non-recommendation condition is satisfied in response to at least one of
   (i) a first condition being satisfied, the first condition being that a collision risk representing a risk that the host vehicle collides with an object is equal to or greater than a threshold risk ("No" at step 525), and
   (ii) a second condition being satisfied, the second condition being that an operation amount of an acceleration operator of the host vehicle is equal to or greater than a threshold amount ("Yes" at step 530).

When the first condition is satisfied, if the following recommendation image is displayed and the driver performs the following operation, there is a high possibility that a collision risk is further increased. When the second condition is satisfied, there is a high possibility that the host vehicle is performing rapid acceleration. In such cases, if the following recommendation image is displayed and the driver performs the following operation, there is a high possibility that the host vehicle is further accelerated. As a result, there is a high possibility that the collision risk is increased. According to the present aspect, when at least one of the first condition and the second condition is satisfied, the following recommendation image is not displayed. Accordingly, it is possible to reduce a possibility that the following operation is performed, thereby reducing a possibility that the collision risk is increased.

In the above aspect,

the driving assistance apparatus is configured to:
execute driving assistance control for causing the host vehicle to travel either at a preset set vehicle speed or while maintaining an inter-vehicle distance between the host vehicle and a preceding vehicle traveling ahead of the host vehicle in a host lane in which the host vehicle is traveling at a preset set distance;
suspend the driving assistance control and cause the host vehicle to travel with a driving force corresponding to the operation amount in response to the second condition being satisfied during execution of the driving assistance control; and
determine that the non-recommendation condition is satisfied in response to the second condition being satisfied ("Yes" at step 530).

When the second condition is satisfied during execution of the driving assistance control, an accelerator override is performed. That is, the driving assistance control is suspended, and the host vehicle travels with the driving force corresponding to the operation amount of the acceleration operator. During such an accelerator override, there is a high possibility that the host vehicle is performing rapid acceleration. In such a case, if the following operation is performed, there is a high possibility that the host vehicle is further accelerated. As a result, there is a high possibility that the collision risk is increased. According to the present aspect, when the second condition is satisfied, the following recommendation image is not displayed. Accordingly, it is possible to reduce a possibility that the following operation is performed, thereby reducing a possibility that the collision risk is increased.

In one aspect of the present apparatus,

the driving assistance device is configured to:
display, as the energy efficiency improvement image, in addition to the following recommendation image, an energy efficiency state image (58) representing a current energy efficiency improvement level of the host vehicle, the energy efficiency improvement level being acquired based at least on the air resistance reduction effect of a preceding vehicle traveling ahead of the host vehicle in a host lane in which the host vehicle is traveling (step 540, step 550).

By viewing the energy efficiency state image, the driver can recognize the current energy efficiency improvement level of the host vehicle. Accordingly, the driver is more likely to perform a driving operation that increases the energy efficiency improvement level of the host vehicle, thereby increasing a possibility that energy efficiency of the host vehicle is improved.

In one aspect of the present apparatus,

the driving assistance apparatus is configured to acquire the air resistance reduction effect based at least on a projected area of a rear surface of another vehicle traveling ahead of the host vehicle (step 605, step 610, step 735).

As the projected area increases, the air resistance reduction effect increases. Accordingly, according to the present aspect, the air resistance reduction effect can be acquired more accurately.

In one aspect of the present apparatus,

the driving assistance apparatus is configured to:
determine whether or not the host vehicle is able to change lanes to an adjacent lane adjacent to a host lane in which the host vehicle is traveling (step 550), in response to determining that an adjacent vehicle traveling ahead of the host vehicle in the adjacent lane is the recommended following vehicle (step 535); and
not display the following recommendation image for the adjacent vehicle in response to determining that the host vehicle is not able to change lanes to the adjacent lane ("No" at step 550).

If the following recommendation image for the adjacent vehicle is displayed even though the host vehicle is not able to change lanes, the driver may perform a driving operation for lane changing as the following operation. When such a following operation is performed, there is a possibility that the collision risk is increased. According to the present aspect, when the host vehicle is not able to change lanes, the following recommendation image for the adjacent vehicle is not displayed. Accordingly, it is possible to reduce a possibility that the driving operation for lane changing is performed as the following operation, thereby reducing a possibility that the collision risk is increased.

In the above aspect,

the driving assistance apparatus is configured to:

in response to determining that both
   (i) a preceding vehicle traveling in a host lane in which the host vehicle is traveling and having the air resistance reduction effect equal to or greater than the predetermined value, and
   (ii) an adjacent vehicle traveling in an adjacent lane adjacent to the host lane and having the air resistance reduction effect equal to or greater than the predetermined value

are present ("Yes" at step 615),

identify, as the recommended following vehicle, the one having a greater air resistance reduction effect (step 620).

According to the present aspect, the following recommendation image for the preceding vehicle and the following recommendation image for the adjacent vehicle

are not displayed at the same time. Accordingly, it is possible to reduce a possibility that the driver is confused as to whether a vehicle to be followed is the preceding vehicle or the adjacent vehicle.

In the above aspect,

the driving assistance apparatus is configured to:

in response to determining that both
(i) the preceding vehicle traveling in the host lane in which the host vehicle is traveling and having the air resistance reduction effect equal to or greater than the predetermined value, and
(ii) the adjacent vehicle traveling in the adjacent lane adjacent to the host lane and having an air resistance reduction effect equal to or greater than the predetermined value

are present, and that the air resistance reduction effect of the adjacent vehicle is greater than that of the preceding vehicle,

determine whether or not the host vehicle is able to change lanes to the adjacent lane (step 550); and

in response to determining that the host vehicle is not able to change lanes to the adjacent lane ("No" at step 550),

identify the preceding vehicle having the air resistance reduction effect equal to or greater than the predetermined value as the recommended following vehicle, and

display the following recommendation image for the preceding vehicle.

If the following recommendation image suddenly ceases to be displayed due to the host vehicle being unable to change lanes to the adjacent lane, the driver may feel discomfort. According to the present embodiment, when the host vehicle is not able to change lanes, the following recommendation image for the preceding vehicle having the air resistance reduction effect equal to or greater than the predetermined value is displayed. Accordingly, it is possible to reduce a possibility that the driver feels discomfort.

In a driving assistance method according to the present disclosure, a computer mounted on a host vehicle displays, on a display device of the host vehicle, an energy efficiency improvement image for improving energy efficiency of the host vehicle.

The driving assistance method comprising:
displaying, by the computer, as the energy efficiency improvement image, a following recommendation image (56) that recommends the host vehicle to follow behind a recommended following vehicle traveling ahead of the host vehicle and having an air resistance reduction effect, which reduces air resistance acting on the host vehicle, equal to or greater than a predetermined value (step 540, step 545); and
not displaying, by the computer, the following recommendation image in response to a non-recommendation condition being satisfied ("No" at step 525, "Yes" at step 530), the non-recommendation condition being a condition that is satisfied when a driving operation for following behind the recommended following vehicle is not recommended.

A non-transitory computer-readable storage medium storing a program according to the present disclosure causes a computer mounted on a host vehicle to display, on a display device of the host vehicle, an energy efficiency improvement image for improving energy efficiency of the host vehicle.

The program causing the computer to execute:
displaying, as the energy efficiency improvement image, a following recommendation image (56) that recommends the host vehicle to follow behind a recommended following vehicle traveling ahead of the host vehicle and having an air resistance reduction effect, which reduces air resistance acting on the host vehicle, equal to or greater than a predetermined value (step 540, step 545); and
not displaying the following recommendation image in response to a non-recommendation condition being satisfied ("No" at step 525, "Yes" at step 530), the non-recommendation condition being a condition that is satisfied when a driving operation for following behind the recommended following vehicle is not recommended.

According to the driving assistance method and the program described above, it is possible to reduce a possibility that the following operation is performed when the non-recommendation condition is satisfied.

### BRIEF DESCRIPTION OF THE DRAWINGS

FIG. 1 is a schematic system configuration diagram of a driving assistance apparatus according to an embodiment of the present disclosure.

FIG. 2 is a diagram illustrating normal constant-speed control and eco constant-speed control.

FIG. 3 is a diagram illustrating a relationship among an inter-vehicle distance, a set distance, and an upper limit value of a distance range.

FIG. 4 is a diagram illustrating a surrounding environment screen.

FIG. 5 is a flowchart of a surrounding environment screen display routine executed by a CPU of an ECU shown in FIG. 1.

FIG. 6 is a flowchart of a recommended following vehicle identification subroutine executed by the CPU of the ECU shown in FIG. 1.

FIG. 7 is a flowchart of an energy efficiency improvement level identification subroutine executed by the CPU of the ECU shown in FIG. 1.

FIG. 8 is a flowchart of an alarm routine executed by the CPU of the ECU shown in FIG. 1.

### DETAILED DESCRIPTION

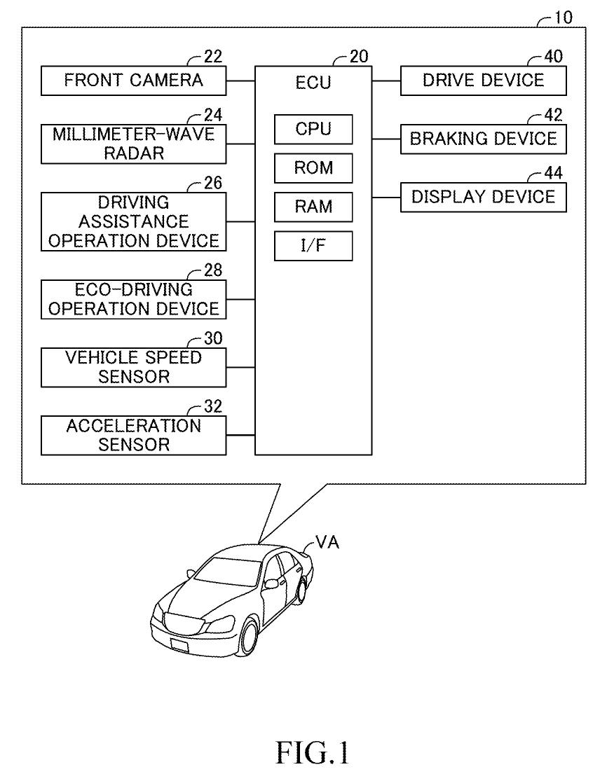

A driving assistance apparatus 10 according to an embodiment of the present disclosure (hereinafter referred to as “the present apparatus 10”) is applied to a host vehicle VA and comprises an ECU 20 shown in FIG. 1. The ECU 20 is an electronic control device mainly including a microcomputer. The ECU 20 may also be referred to as a control unit, a controller, or a computer. The microcomputer includes a CPU (processor), a ROM, a RAM, an interface (I/F), and the like. The functions realized by the ECU 20 may be realized by a plurality of ECUs.

The ECU 20 comprises a front camera 22, a millimeter-wave radar 24, a driving assistance operation device 26, an eco-driving operation device 28, a vehicle speed sensor 30, and an acceleration sensor 32.

The front camera 22 captures an image of a front area of the host vehicle VA to acquire front image data. The millimeter-wave radar 24 transmits millimeter waves forward of the host vehicle VA and receives the millimeter waves reflected by an object, thereby acquiring radar data. The radar data includes data relating to a position of the object relative to the host vehicle VA and data relating to a relative speed Vr of the object with respect to the host vehicle VA.

The ECU 20 acquires the front image data from the front camera 22 and acquires the radar data from the millimeter-wave radar 24. The ECU 20 recognizes the object in front of the host vehicle VA based on the front image data and the radar data.

The driving assistance operation device 26 is a device operated by a driver and includes switches, buttons, and the like. The driving assistance operation device 26 is disposed in the vicinity of a steering wheel of the host vehicle VA. The driving assistance operation device 26 includes a driving assistance selection switch, a vehicle speed setting switch, a vehicle speed increase button, a vehicle speed decrease button, and an inter-vehicle distance setting button.

When the driving assistance selection switch is operated by the driver while driving assistance control described below is not being executed, the driving assistance operation device 26 transmits a signal to the ECU 20. Upon receiving the signal, the ECU 20 determines that the driver requests execution of the driving assistance control. On the other hand, when the driving assistance selection switch is operated by the driver while the driving assistance control is being executed, the driving assistance operation device 26 transmits a signal to the ECU 20. Upon receiving the signal, the ECU 20 determines that the driver requests termination of the driving assistance control.

When the vehicle speed setting switch is operated by the driver while the driving assistance control is being executed, the driving assistance operation device 26 transmits a signal to the ECU 20. Upon receiving the signal, the ECU 20 sets the vehicle speed Vs of the host vehicle VA at that time as a set vehicle speed Vset for the driving assistance control.

When the vehicle speed increase button is operated by the driver while the driving assistance control is being executed, the driving assistance operation device 26 transmits a signal to the ECU 20. Upon receiving the signal, the ECU 20 increases the set vehicle speed Vset. On the other hand, when the vehicle speed decrease button is operated by the driver while the driving assistance control is being executed, the driving assistance operation device 26 transmits a signal to the ECU 20. Upon receiving the signal, the ECU 20 decreases the set vehicle speed Vset.

When the inter-vehicle distance setting button is operated by the driver while the driving assistance control is being executed, the driving assistance operation device 26 transmits a signal to the ECU 20. Upon receiving the signal, the ECU 20 changes a set distance Dset described below.

An eco-driving operation device 28 is a device operated by the driver and includes switches, buttons, and the like. The eco-driving operation device 28 is disposed in the vicinity of the steering wheel of the host vehicle VA. When the eco-driving operation device 28 positioned at an OFF position is operated, the eco-driving operation device 28 is moved to an ON position. When the eco-driving operation device 28 is moved to the ON position, the eco-driving operation device 28 transmits a signal to the ECU 20. Upon receiving the signal, the ECU 20 determines that the driver requests execution of eco-driving control described below.

When the eco-driving operation device 28 positioned at the ON position is operated, the eco-driving operation device 28 is moved to the OFF position. When the eco-driving operation device 28 is moved to the OFF position, the eco-driving operation device 28 transmits a signal to the ECU 20. Upon receiving the signal, the ECU 20 determines that the driver does not request execution of the eco-driving control described below.

A vehicle speed sensor 30 measures a vehicle speed Vs. An acceleration sensor 32 measures an acceleration G of the host vehicle VA. The ECU 20 acquires measurement values from the vehicle speed sensor 30 and the acceleration sensor 32.

A drive device 40 outputs driving force for causing the host vehicle VA to travel. For example, the drive device 40 includes an internal combustion engine and/or a motor. The ECU 20 controls the drive device 40 so as to control the driving force output by the drive device 40. A braking device 42 is a device that outputs braking force for braking the host vehicle VA. The ECU 20 controls the braking device 42 so as to control the braking force output by the braking device 42. A display device 44 is disposed at a position visible to the driver.

### Driving Assistance Control

When execution of driving assistance control is requested, the ECU 20 executes the driving assistance control. The driving assistance control includes normal driving assistance control and eco-driving assistance control. The normal driving assistance control includes normal constant-speed control and normal following control, and the eco-driving assistance control includes eco constant-speed control and eco following control. The eco-driving assistance control is driving control having higher energy efficiency than the normal driving assistance control. When the driver desires to improve energy efficiency of the host vehicle VA, the driver requests execution of the eco-driving assistance control.

### Normal Driving Assistance Control

When the driving assistance control is requested and the eco-driving assistance control is not requested, the ECU 20 executes the normal driving assistance control. Specifically, the ECU 20 determines whether or not a target preceding vehicle VB (see FIG. 3) is present. When the target preceding vehicle VB is not present, the ECU 20 executes the normal constant-speed control as the normal driving assistance control. On the other hand, when the target preceding vehicle VB is present, the ECU 20 executes the normal following control as the normal driving assistance control.

The ECU 20 identifies another vehicle that satisfies the following conditions S1 and S2 as the target preceding vehicle VB.

Condition S1: The other vehicle travels ahead of the host vehicle VA in the same lane in which the host vehicle VA travels.

Condition S2: An inter-vehicle distance D (see FIG. 3) between the host vehicle VA and the other vehicle is equal to or less than a threshold distance.

### Normal Constant-Speed Control

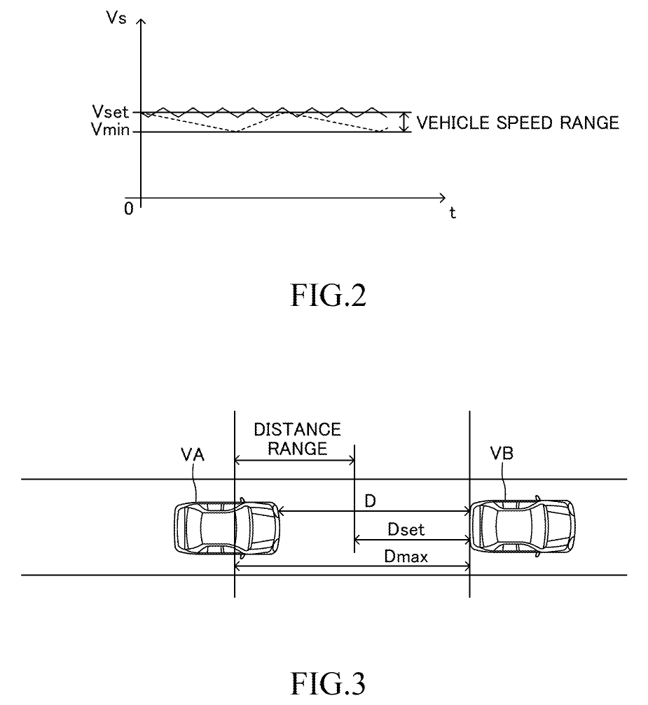

In the normal constant-speed control, the ECU 20 accelerates or decelerates the host vehicle VA such that the vehicle speed Vs is maintained at the set vehicle speed Vset. As indicated by a solid line in FIG. 2, when the vehicle speed Vs is lower than the set vehicle speed Vset, the ECU 20 accelerates the host vehicle VA, and when the vehicle speed Vs is higher than the set vehicle speed Vset, the ECU 20 decelerates the host vehicle VA. More specifically, the ECU 20 acquires a required acceleration Greq such that a speed at which the vehicle speed Vs converges to the set vehicle speed Vset is equal to or higher than a predetermined speed, and acquires a required braking force or a required driving force for achieving the required acceleration Greq. The ECU 20 then controls the drive device 40 and/or the braking device 42 so that the required braking force or the required driving force is output.

### Normal Following Control

In the normal following control, the ECU 20 accelerates or decelerates the host vehicle VA such that the inter-vehicle distance D shown in FIG. 3 is maintained at the set distance Dset. When the inter-vehicle distance D becomes longer than the set distance Dset, the ECU 20 accelerates the host vehicle VA, and when the inter-vehicle distance D becomes shorter than the set distance Dset, the ECU 20 decelerates the host vehicle VA. More specifically, the ECU 20 acquires the required acceleration Greq such that a speed at which the inter-vehicle distance D converges to the set distance Dset is equal to or higher than a predetermined speed, and acquires the required

braking force or the required driving force for achieving the required acceleration Greq. The ECU 20 then controls the drive device 40 and/or the braking device 42 so that the required braking force or the required driving force is output.

In the normal constant-speed control and the normal following control, control for controlling the drive device 40 and/or the braking device 42 so that the required driving force for achieving the required acceleration Greq is output is referred to as “normal acceleration control,” and control for controlling the drive device 40 and/or the braking device 42 so that the required braking force for achieving the required acceleration Greq is output is referred to as “normal deceleration control.”

### Eco-Driving Assistance Control

When the driving assistance control is requested and the eco-driving assistance control is requested, the ECU 20 executes the eco-driving assistance control. Specifically, when the target preceding vehicle VB is not present, the ECU 20 executes the eco constant-speed control as the eco-driving assistance control, and when the target preceding vehicle VB is present, the ECU 20 executes the eco following control as the eco-driving assistance control.

### Eco Constant-Speed Control

In the eco constant-speed control, the ECU 20 accelerates or decelerates the host vehicle VA (that is, controls the acceleration G of the host vehicle VA) such that the vehicle speed Vs is maintained within a vehicle speed range in which the set vehicle speed Vset is set as an upper limit value Vmax. As indicated by a dotted line in FIG. 2, when the vehicle speed Vs is lower than a lower limit value Vmin of the vehicle

speed range, the ECU 20 accelerates the host vehicle VA, and when the vehicle speed Vs exceeds the upper limit value Vmax (the set vehicle speed Vset), the ECU 20 decelerates the host vehicle VA.

When accelerating the host vehicle VA in the eco constant-speed control, the ECU 20 determines, based on the vehicle speed Vs, the acceleration G at which the drive device 40 operates with energy efficiency equal to or higher than a predetermined efficiency, and sets the determined acceleration G as a required acceleration Greq. The ECU 20 controls the drive device 40 and/or the braking device 42 so that the required driving force for achieving the required acceleration Greq is output.

When decelerating the host vehicle VA in the eco constant-speed control, the ECU 20 determines the acceleration G at which the required driving force is zero, and sets the determined acceleration G as the required acceleration Greq. Accordingly, when the host vehicle VA is decelerated in the eco constant-speed control, the host vehicle VA coasts. Hereinafter, such deceleration is referred to as “coasting deceleration.”

When the drive device 40 includes a motor, the ECU 20 may decelerate the host vehicle VA in the eco constant-speed control by rotating the motor using traveling energy of the host vehicle VA to regenerate electric power. Hereinafter, such deceleration is referred to as “regenerative deceleration.”

### Eco Following Control

In the eco following control, the ECU 20 determines a distance range (see FIG. 3) used to determine whether the host vehicle VA is to be accelerated or decelerated. In the present example, a lower limit value Dmin of the distance range is set to the set distance Dset. When the inter-vehicle distance D becomes longer than an upper limit value Dmax of the distance range, the ECU 20 accelerates the host vehicle VA, and when the inter-vehicle distance D becomes shorter than the lower limit value Dmin (the set distance Dset), the ECU 20 decelerates the host vehicle VA. Acceleration and deceleration of the host vehicle VA in the eco following control are performed in the same manner as acceleration and deceleration of the host vehicle VA in the eco constant-speed control.

Control for accelerating the host vehicle VA in the eco constant-speed control and the eco following control is referred to as “eco acceleration control,” and control for decelerating the host vehicle VA in the eco constant-speed control and the eco following control is referred to as “eco deceleration control.” In the eco acceleration control, the host vehicle VA is accelerated with a smaller acceleration than in the normal acceleration control. Acceleration of the host vehicle VA in the eco acceleration control may be referred to as “suppressed acceleration.” In the eco deceleration control, the host vehicle VA is decelerated with a smaller deceleration than in the normal deceleration control.

### Outline of Operation

When the driving assistance control is requested, the ECU 20 displays a surrounding environment screen 50 on the display device 44. The surrounding

environment screen 50 shows a lane image 52, a host vehicle image 54a, a preceding vehicle image 54b, and an adjacent vehicle image 54c.

The lane image 52 is an image of a host lane in which the host vehicle VA is traveling. The ECU 20 extracts lane markings from the front image data and generates the lane image 52 based on positions of the extracted lane markings relative to the host vehicle VA.

The host vehicle image 54a represents the host vehicle VA. The ECU 20 displays a pre-prepared host vehicle image 54a at a predetermined position.

The preceding vehicle image 54b represents a preceding vehicle traveling ahead of the host vehicle VA in the host lane. The preceding vehicle includes not only a target preceding vehicle but also another vehicle having the inter-vehicle distance D longer than the threshold distance described above. The ECU 20 generates the preceding vehicle image 54b based on an image of the preceding vehicle included in the front image data. The ECU 20 then displays the preceding vehicle image 54b at a position corresponding to a position of the preceding vehicle relative to the host vehicle VA, the position being identified based on the front image data and the radar data.

The adjacent vehicle image 54c represents an adjacent vehicle. The adjacent vehicle is another vehicle traveling ahead of the host vehicle VA in an adjacent lane adjacent to the host lane. The ECU 20 generates the adjacent vehicle image 54c based on an image of the adjacent vehicle included in the front image data. The ECU 20 then displays the adjacent vehicle image 54c at a position corresponding to a position of the adjacent vehicle relative to the host vehicle VA, the position being identified based on the front image data and the radar data.

When the driving assistance control is requested and the eco-driving assistance control is requested, the ECU 20 displays energy efficiency improvement images on the surrounding environment screen 50 in order to improve energy efficiency of the host vehicle VA. More specifically, the ECU 20 displays a following recommendation image 56 and an energy efficiency state image 58 as the energy efficiency improvement images.

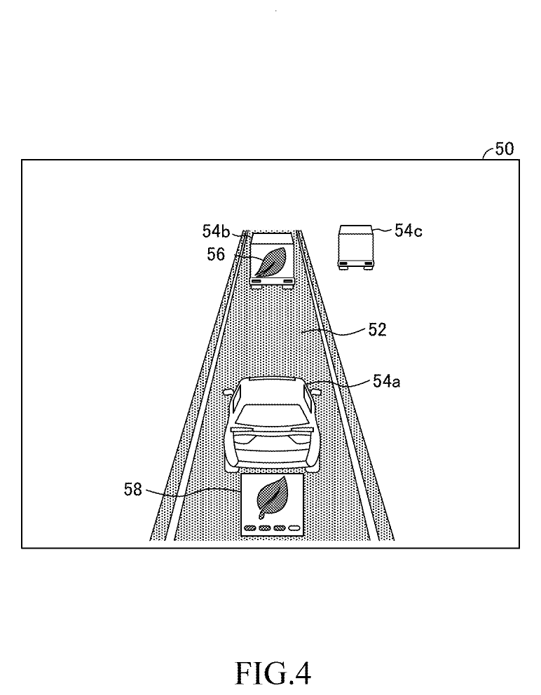

The following recommendation image 56 is an image for recommending that the host vehicle VA follow behind a recommended following vehicle that travels ahead of the host vehicle VA and provides an air resistance reduction effect equal to or greater than a predetermined value. As an example, the following recommendation image 56 is displayed so as to be superimposed on an image of the recommended following vehicle. In the example shown in FIG. 4, a preceding vehicle is identified as the recommended following vehicle, and the following recommendation image 56 is displayed so as to be superimposed on the preceding vehicle image 54b. The following recommendation image 56 does not necessarily have to be displayed in a superimposed manner and may be displayed in association with the following recommendation, for example, in the vicinity of an image of the recommended following vehicle. A method by which the ECU 20 acquires the air resistance reduction effect will be described later.

The energy efficiency state image 58 represents a level at which energy efficiency of the host vehicle VA is improved (hereinafter referred to as an “energy efficiency improvement level”). In the present embodiment, the energy efficiency state image 58 represents the energy efficiency improvement level in five stages from “0” to “4.” As the energy efficiency improvement level increases, the energy efficiency of the host vehicle VA is improved. A method by which the ECU 20 acquires the energy efficiency improvement level will be described later.

By displaying the following recommendation image 56, the driver causes the host vehicle VA to follow behind a vehicle having a high air resistance reduction effect. As a result, the energy efficiency of the host vehicle VA is improved. Furthermore, by displaying the energy efficiency state image 58, the driver can recognize a current energy efficiency improvement level. Accordingly, the energy efficiency state image 58 motivates the driver to continuously use the eco-driving assistance control.

When the energy efficiency improvement images are displayed, a possibility increases that the driver performs a following operation, which is a driving operation for causing the host vehicle VA to travel behind the recommended following vehicle, even in a situation in which performing the following operation is not recommended. For example, a situation in which a collision risk between the host vehicle VA and an object is equal to or higher than a threshold risk, and a situation in which there is a high possibility that the host vehicle VA is rapidly accelerating, are situations in which performing the following operation is not recommended.

Therefore, in the present embodiment, when a non-recommendation condition that is satisfied in a case where performing the following operation by the driver is not recommended is satisfied, the ECU 20 prohibits display of the energy efficiency improvement images. Accordingly, it is possible to reduce a possibility that the driver performs the following operation in a situation in which performing the following operation is not recommended.

### Specific Operation

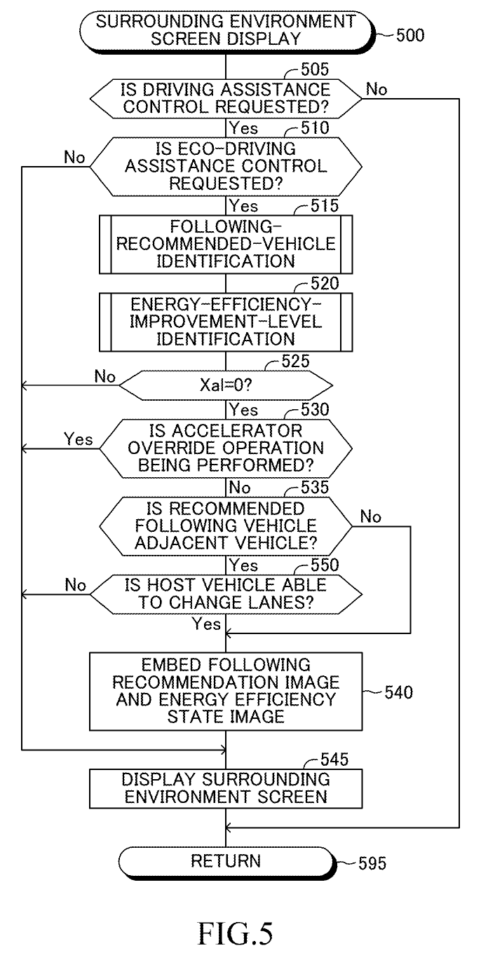

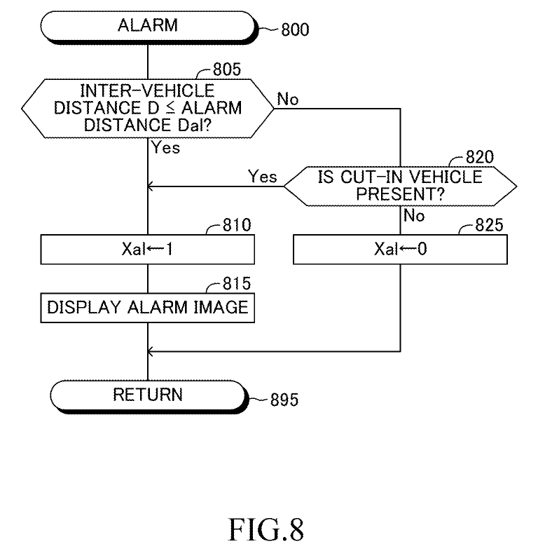

The CPU of the ECU 20 executes routines shown in flowcharts of FIGS. 5 and 8 each time a predetermined period elapses.

### Surrounding Environment Screen Display Routine

When an appropriate timing arrives, the CPU starts processing from step 500 in FIG. 5, and the processing proceeds to step 505. At step 505, the CPU determines whether or not the driving assistance control is requested.

When the driving assistance control is not requested, the CPU makes a “No” determination at step 505, and the processing proceeds to step 595. At step 595, the CPU temporarily ends the present routine. As a result, when the driving assistance control is not requested, the surrounding environment screen 50 is not displayed.

When the driving assistance control is requested, the CPU makes a “Yes” determination at step 505, and the processing proceeds to step 510. At step 510, the CPU determines whether or not the eco-driving assistance control is requested.

When the eco-driving assistance control is requested, the CPU makes a “Yes” determination at step 510 and executes steps 515 to 525.

Step 515: The CPU executes a following-recommended-vehicle identification subroutine for identifying a recommended following vehicle. Details of the following-recommended-vehicle identification subroutine will be described later.

Step 520: The CPU executes an energy-efficiency-improvement-level identification subroutine for identifying the energy efficiency improvement level. Details of the energy-efficiency-improvement-level identification subroutine will be described later.

Step 525: The CPU determines whether or not an alarm flag Xal is “0.”

The alarm flag Xal is set to “1” when the ECU 20 issues an alarm and is set to “0” when the ECU 20 does not issue the alarm. The alarm flag Xal is set to “0” in an initialization routine. The initialization routine is executed by the CPU when an ignition key switch (not shown) of the host vehicle VA is changed from an OFF position to an ON position. The ECU 20 issues the alarm when the collision risk is equal to or higher than the threshold risk. Details thereof will be described later.

When the alarm flag Xal is “0,” the CPU makes a “Yes” determination at step 525, and the processing proceeds to step 530. At step 530, the CPU determines whether or not the driver is performing an accelerator override operation.

The CPU determines that the driver is performing the accelerator override operation during a period from when both the following conditions A1 and A2 are satisfied until a condition A3 is satisfied.

Condition A1: An accelerator operation amount is equal to or greater than a first threshold amount.

Condition A2: An accelerator operation speed is equal to or greater than a threshold speed.

The accelerator operation amount represents an amount by which the driver depresses an accelerator pedal. The accelerator operation speed represents a change amount per unit time of the amount by which the driver depresses the accelerator pedal. The accelerator pedal may also be referred to as an “acceleration operator.”

Condition A3: The accelerator operation amount is equal to or less than a second threshold amount that is smaller than the first threshold amount.

When the driver is performing the accelerator override operation, the ECU 20 performs accelerator override. Specifically, the ECU 20 suspends the normal driving assistance control or the eco-driving assistance control, and controls the drive device 40 and/or the braking device 42 so that the required driving force corresponding to the accelerator operation amount is output. Accordingly, when the driver is performing the accelerator override operation, there is a high possibility that the host vehicle VA rapidly accelerates.

When the alarm flag Xal is “0” and the driver is not performing the accelerator override operation, the non-recommendation condition is not satisfied.

When the driver is not performing the accelerator override operation at step 530, the CPU makes a “No” determination at step 530, and the processing proceeds to step 535. At step 535, the CPU determines whether or not the recommended following vehicle is an adjacent vehicle.

When the recommended following vehicle is not an adjacent vehicle (that is, when the recommended following vehicle is a preceding vehicle), the CPU makes a “No” determination at step 535 and executes steps 540 and 545.

Step 540: The CPU embeds the following recommendation image 56 in an image of the recommended following vehicle, and embeds the energy efficiency state image 58 below the host vehicle image 54a.

Step 545: The CPU displays the surrounding environment screen 50 on the display device 44.

More specifically, the CPU generates the surrounding environment screen 50 by arranging the preceding vehicle image 54b and the adjacent vehicle image 54c relative to the host vehicle image 54a based on positions of the preceding vehicle and the adjacent vehicle relative to the host vehicle VA, and displays the generated surrounding environment screen 50 on the display device 44.

Thereafter, the processing proceeds to step 595.

When the alarm flag Xal is “1” at a time when the processing proceeds to step 525, the non-recommendation condition is satisfied. In this case, the CPU makes a “No” determination at step 525, and the processing proceeds to step 545. As a result, since step 540 is not executed, the energy efficiency improvement images (the following recommendation image 56 and the energy efficiency state image 58) are not displayed on the surrounding environment screen 50.

When the driver is performing the accelerator override operation at a time when the processing proceeds to step 530, the normal driving assistance control or the eco-driving assistance control is suspended as described above, and thus there is a high possibility that the host vehicle VA rapidly accelerates. If the following operation is performed in such a situation, the collision risk increases. Therefore, in the present embodiment, the CPU determines that the non-recommendation condition is satisfied in such a case. In this case, the CPU makes a “No” determination at step 530, and the processing proceeds to step 545. As a result, the energy efficiency improvement images are not displayed on the surrounding environment screen 50.

When the recommended following vehicle is an adjacent vehicle at a time when the processing proceeds to step 535, the CPU makes a “Yes” determination at step 535, and the processing proceeds to step 550. At step 550, the CPU determines, based on the front image data and the radar data, whether or not the host vehicle VA is able to change lanes to an adjacent lane in which the adjacent vehicle that is the recommended following vehicle is traveling.

When the following recommendation image 56 is displayed in a case where the host vehicle VA is not able to change lanes to the adjacent lane, a possibility increases that the driver performs a lane change. Therefore, when the host vehicle VA is not able to change lanes to the adjacent lane, the non-recommendation condition is satisfied.

On the other hand, when the host vehicle VA is able to change lanes to the adjacent lane, the non-recommendation condition is not satisfied. In this case, the CPU makes a “Yes” determination at step 550, and the processing proceeds to step 540. As a result, the energy efficiency improvement images are displayed on the surrounding environment screen 50.

When the eco-driving assistance control is not requested at a time when the processing proceeds to step 510, the CPU makes a “No” determination at step 510, and the processing proceeds to step 545. As a result, the energy efficiency improvement images are not displayed on the surrounding environment screen 50.

### Following-Recommended-Vehicle Identification Subroutine

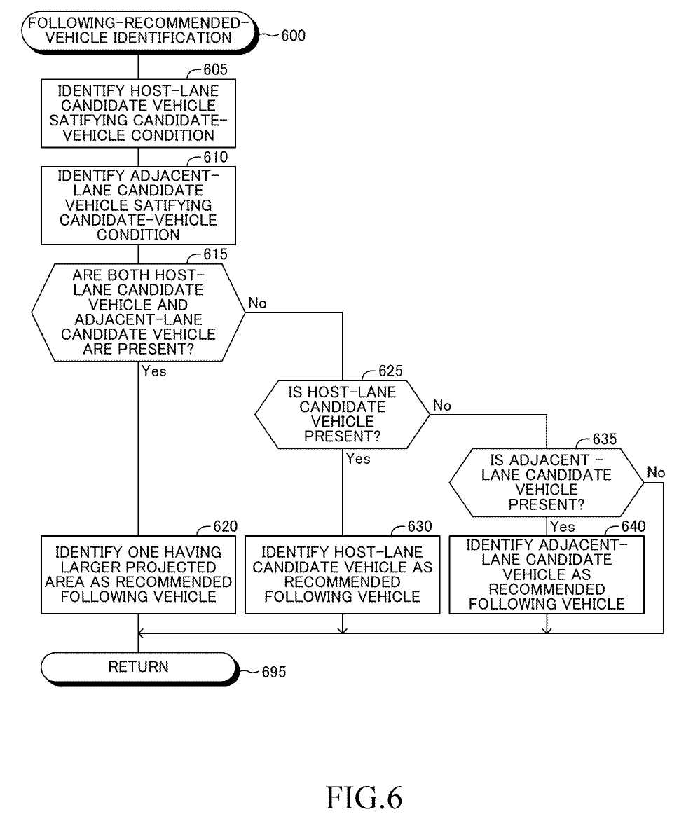

When the processing proceeds to step 515, the CPU starts processing from step 600 shown in FIG. 6 and executes steps 605 to 615.

Step 605: When another vehicle traveling ahead of the host vehicle VA in the host lane (a preceding vehicle) satisfies a candidate-vehicle condition, the CPU identifies the other vehicle as a host-lane candidate vehicle.

Specifically, the CPU determines that the other vehicle satisfies the candidate-vehicle condition when the other vehicle satisfies the following conditions C1 to C3.

Condition C1: A projected area of the other vehicle is equal to or greater than a threshold area.

The projected area is an area of a rear surface of the other vehicle. The CPU acquires the projected area based on an image of the other vehicle included in the front image data.

Condition C2: Another-vehicle speed Vo, which represents a vehicle speed of the other vehicle, is equal to or greater than a first threshold speed V1th.

Condition C3: The other-vehicle speed Vo is equal to or greater than a first subtracted value acquired by subtracting a first predetermined value V1pd from the set vehicle speed Vset, and is equal to or less than a second subtracted value acquired by subtracting a second predetermined value V2pd from the set vehicle speed Vset. The first predetermined value V1pd is set to be greater than the second predetermined value V2pd.

Step 610: When another vehicle traveling ahead of the host vehicle VA in an adjacent lane adjacent to the host lane (an adjacent vehicle) satisfies the candidate-vehicle condition, the CPU identifies the other vehicle as an adjacent-lane candidate vehicle.

Step 615: The CPU determines whether or not both the host-lane candidate vehicle and the adjacent-lane candidate vehicle are present.

When both the host-lane candidate vehicle and the adjacent-lane candidate vehicle are present, the CPU makes a “Yes” determination at step 615, and the processing proceeds to step 620. At step 620, the CPU identifies, as the recommended following vehicle, one of the host-lane candidate vehicle and the adjacent-lane candidate vehicle having a larger projected area. Thereafter, the processing proceeds to step 695, and the CPU temporarily ends the present routine. Then, the processing proceeds to step 520 shown in FIG. 5. Accordingly, since only one following recommendation image 56 is displayed (that is, the following recommendation image 56 for the preceding vehicle and the following recommendation image 56 for the adjacent vehicle are not displayed simultaneously), it is possible to reduce a possibility that the driver hesitates as to whether a vehicle to be followed is the preceding vehicle or the adjacent vehicle.

When at least one of the host-lane candidate vehicle and the adjacent-lane candidate vehicle is not present, the CPU makes a “No” determination at step 615, and the processing proceeds to step 625. At step 625, the CPU determines whether or not the host-lane candidate vehicle is present.

When the host-lane candidate vehicle is present, the CPU makes a “Yes” determination at step 625, and the processing proceeds to step 630. At step 630, the CPU identifies the host-lane candidate vehicle as the recommended following vehicle. Thereafter, the processing proceeds to step 695.

When the host-lane candidate vehicle is not present, the CPU makes a “No” determination at step 625, and the processing proceeds to step 635. At step 635, the CPU determines whether or not the adjacent-lane candidate vehicle is present.

When the adjacent-lane candidate vehicle is present, the CPU makes a “Yes” determination at step 635, and the processing proceeds to step 640. At step 640, the

CPU identifies the adjacent-lane candidate vehicle as the recommended following vehicle. Thereafter, the processing proceeds to step 695.

When the adjacent-lane candidate vehicle is not present, the CPU makes a “No” determination at step 635, and the processing proceeds to step 695. In this case, since no recommended following vehicle is present, the following recommendation image 56 is not displayed.

### Energy Efficiency Improvement Level Identification Subroutine

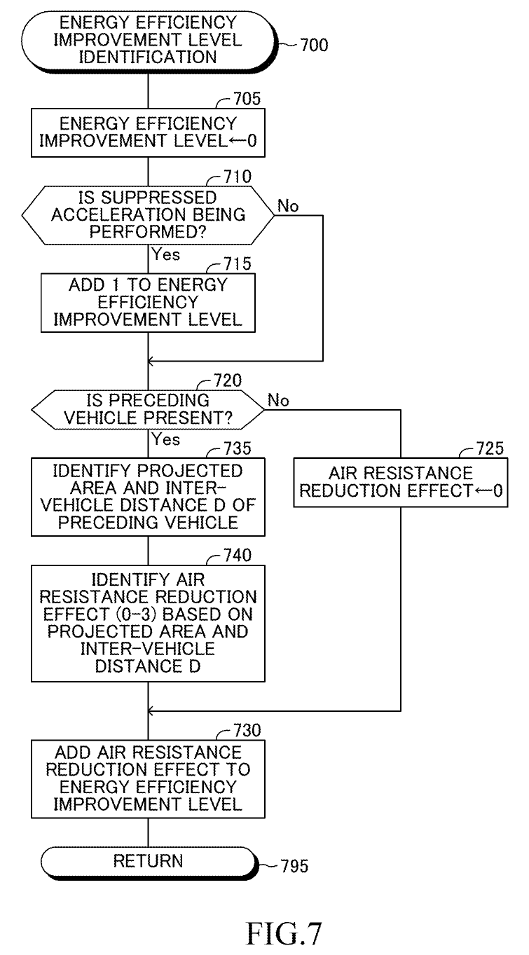

When the processing proceeds to step 520 shown in FIG. 5, the CPU starts processing from step 700 shown in FIG. 7 and executes steps 705 and 710.

Step 705: The CPU sets the energy efficiency improvement level to “0.”

Step 710: The CPU determines whether or not the host vehicle VA is performing suppressed acceleration in the eco-driving assistance control.

When the host vehicle VA is performing suppressed acceleration, the CPU makes a “Yes” determination at step 710 and executes steps 715 and 720.

Step 715: The CPU adds “1” to the energy efficiency improvement level.

Step 720: The CPU determines whether or not a preceding vehicle is present.

When no preceding vehicle is present, the CPU makes a “No” determination at step 720 and executes steps 725 and 730.

Step 725: The CPU sets the air resistance reduction effect to “0.”

Step 730: The CPU adds the air resistance reduction effect to the energy efficiency improvement level.

Thereafter, the processing proceeds to step 795, the CPU temporarily ends the present routine, and the processing proceeds to step 525 shown in FIG. 5.

When the host vehicle VA is not performing suppressed acceleration at a time when the processing proceeds to step 710, the CPU makes a “No” determination at step 710, and the processing proceeds to step 720.

When a preceding vehicle is present at a time when the processing proceeds to step 720, the CPU makes a “Yes” determination at step 720 and executes steps 735 and 740.

Step 735: The CPU identifies the projected area of the preceding vehicle and the inter-vehicle distance D.

Step 740: The CPU identifies the air resistance reduction effect in four stages from “0” to “3” based on the projected area of the preceding vehicle and the inter-vehicle distance D.

The air resistance reduction effect increases as the projected area becomes larger and as the inter-vehicle distance D becomes shorter.

Thereafter, the processing proceeds to step 730, and the CPU adds the air resistance reduction effect identified at step 740 to the energy efficiency improvement level.

### Alarm Routine

When an appropriate timing arrives, the CPU starts processing from step 800 in FIG. 8, and the processing proceeds to step 805. At step 805, the CPU determines whether or not the inter-vehicle distance D between the preceding vehicle and the host vehicle VA is equal to or less than an alarm distance Dal. The alarm distance Dal is set to be smaller than the set distance Dset.

When the inter-vehicle distance D is equal to or less than the alarm distance Dal, the CPU determines that the collision risk is equal to or higher than the threshold risk. In this case, the CPU makes a “Yes” determination at step 805 and executes steps 810 and 815.

Step 810: The CPU sets the alarm flag Xal to “1.”

Step 815: The CPU displays, on the display device 44, an alarm image for notifying the driver that the collision risk is high.

Thereafter, the processing proceeds to step 895, and the CPU temporarily ends the present routine.

When the inter-vehicle distance D is greater than the alarm distance Dal, the CPU makes a “No” determination at step 805, and the processing proceeds to step 820. At step 820, the CPU determines, based on the front image data and the radar data, whether or not a cut-in vehicle that cuts in front of the host vehicle VA is present.

When a cut-in vehicle is present, the CPU determines that the collision risk is equal to or higher than the threshold risk. In this case, the CPU makes a “Yes” determination at step 820 and executes steps 810 and 815. As a result, the alarm image is displayed on the display device 44.

When no cut-in vehicle is present, the CPU makes a “No” determination at step 820, and the processing proceeds to step 825. At step 825, the CPU sets the alarm flag Xal to “0.” Thereafter, the processing proceeds to step 895.

According to the present embodiment, the ECU 20 determines that the non-recommendation condition is satisfied when the collision risk is equal to or higher than the threshold risk and/or when the driver is performing the accelerator override operation. When the non-recommendation condition is satisfied, the ECU 20 does not display the energy efficiency improvement images. Accordingly, it is possible to reduce a possibility that the following operation is performed in a situation in which performing the following operation is not recommended.

The present disclosure is not limited to the embodiments described above, and various modifications of the present disclosure can be adopted.

### First Modification

In the above-described embodiment, when the adjacent-lane candidate vehicle is identified as the recommended following vehicle (step 535: “Yes”) and the host vehicle VA is not able to change lanes to the adjacent lane in which the recommended following vehicle is traveling (step 550: “No”), the ECU 20 does not display both the following recommendation image 56 and the energy efficiency state image 58.

However, in this case, the ECU 20 may display the energy efficiency state image 58 without displaying the following recommendation image 56.

Further, when the host vehicle VA is not able to change lanes to the adjacent lane in which the recommended following vehicle is traveling, the ECU 20 may newly identify, as the recommended following vehicle, the host-lane candidate vehicle when the host-lane candidate vehicle is present, and may display the following recommendation image 56 of the host-lane candidate vehicle. Accordingly, it is possible to reduce a possibility that the following recommendation image 56 suddenly disappears when the host vehicle VA is not able to change lanes to the adjacent lane, thereby reducing a possibility that the driver feels discomfort.

### Second Modification

In the above-described embodiment, at step 530 of the surrounding environment screen display routine shown in FIG. 5, the ECU 20 determines that the driver is performing the accelerator override operation when both the above-described conditions A1 and A2 are satisfied. However, the ECU 20 may determine that the driver is performing the accelerator override operation when the above-described condition A1 is satisfied.

### Third Modification

In the above-described embodiment, in the surrounding environment screen display routine shown in FIG. 5, when the driving assistance control is requested and eco-driving assistance control is requested, the ECU 20 displays the following recommendation image 56 and the energy efficiency state image 58 as energy

efficiency improvement images (step 540). However, the ECU 20 may display at least the following recommendation image 56 as the energy efficiency improvement image. Further, the ECU 20 may display the energy efficiency improvement images regardless of whether the driving assistance control is requested and regardless of whether the eco-driving assistance control is requested.

When the driving assistance control is not requested, the driving assistance control is not executed. Therefore, regardless of whether the driver is performing the accelerator override operation, the host vehicle VA travels with the required driving force corresponding to the accelerator operation amount. In this case, when at least a condition that an accelerator operation amount AP is equal to or greater than a third threshold amount is satisfied, the ECU 20 determines that the non-recommendation condition is satisfied and does not display the energy efficiency improvement images. The third threshold amount may be the same as or different from the first threshold amount of condition A1.

### Fourth Modification

In the above-described embodiment, in the energy efficiency improvement level identification subroutine shown in FIG. 7, when the host vehicle VA is performing suppressed acceleration (step 710: “Yes”), the ECU 20 adds “1” to the energy efficiency improvement level. However, the ECU 20 does not necessarily have to add “1” to the energy efficiency improvement level even when the host vehicle VA is performing suppressed acceleration. That is, the ECU 20 only needs to acquire the energy efficiency improvement level at least based on the air resistance reduction effect of the preceding vehicle.

### Fifth Modification

In the above-described embodiment, in the alarm routine shown in FIG. 8, when the inter-vehicle distance D is equal to or less than the alarm distance Dal (step 805: “Yes”), the ECU 20 issues an alarm (step 815). However, the ECU 20 may use a time to collision (TTC) of the preceding vehicle instead of the inter-vehicle distance D. The TTC represents a time required until an object collides with the host vehicle VA and is an abbreviation of “Time To Collision.” The ECU 20 acquires the TTC by dividing the inter-vehicle distance D by a relative speed Vr of the preceding vehicle with respect to the host vehicle VA. When the TTC is equal to or less than an alarm time Tal, the ECU 20 determines that the collision risk is equal to or higher than the threshold risk and issues an alarm.

Further, in the above-described embodiment, the ECU 20 issues an alarm by displaying an alarm image. However, the ECU 20 may issue an alarm by outputting a predetermined alarm sound from a speaker (not shown).

### Sixth Modification

In the normal constant-speed control of the present modification, when the vehicle speed Vs is lower than a lower limit value of a vehicle speed range, the ECU 20 performs the normal acceleration control, and when the vehicle speed Vs exceeds an upper limit value of a vehicle speed range, the ECU 20 performs the normal deceleration control. The vehicle speed range in the eco constant-speed control is set to be wider than the vehicle speed range in the normal constant-speed control.

In the normal following control of the present modification, when the inter-vehicle distance D exceeds an upper limit value of a distance range, the ECU 20 performs the normal acceleration control, and when the inter-vehicle distance D becomes shorter than a set distance Dset that is a lower limit value of the distance range, the ECU 20 performs the normal deceleration control. The distance range in the eco following control is set to be wider than the distance range in the normal following control.

### Seventh Modification

In the normal following control and the eco following control, the TTC described above may be used instead of the inter-vehicle distance D.

### Eighth Modification

In the above-described embodiment, the upper limit value Vmax of the vehicle speed range in the eco constant-speed control is set to the set vehicle speed Vset. However, the vehicle speed range only needs to include the set vehicle speed Vset. Further, in the eco following control, the lower limit value Dmin of the distance range is set to the set distance Dset. However, the distance range only needs to include the set distance Dset.

### Ninth Modification

The eco deceleration control is not limited to coasting deceleration and regenerative deceleration. The eco deceleration control may be any control in which a deceleration is smaller than a deceleration in the normal deceleration control.

### Tenth Modification

The apparatus 10 does not necessarily need to include both the front camera 22 and the millimeter-wave radar 24, and may include at least one device capable of detecting an object.

The present apparatus 10 can be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). Furthermore, the present apparatus 10 can also be applied to an autonomous driving vehicle. The present disclosure can be understood as a non-transitory computer-readable storage medium in which a program for realizing the functions of the present apparatus 10 is stored.

What is claimed is:

1. A driving assistance apparatus configured to display, on a display device of a host vehicle, an energy efficiency improvement image for improving energy efficiency of the host vehicle,
wherein the driving assistance apparatus is configured to:
display, as the energy efficiency improvement image, a following recommendation image that recommends the host vehicle to follow behind a recommended following vehicle traveling ahead of the host vehicle and having an air resistance reduction effect, which reduces air resistance acting on the host vehicle, equal to or greater than a predetermined value; and
not display the following recommendation image in response to a non-recommendation condition being satisfied, the non-recommendation condition being a condition that is satisfied when a driving operation for following behind the recommended following vehicle is not recommended.

2. The driving assistance apparatus according to claim 1,
wherein the driving assistance apparatus is configured to:
determine that the non-recommendation condition is satisfied in response to at least one of
(i) a first condition being satisfied, the first condition being that a collision risk representing a risk that the host vehicle collides with an object is equal to or greater than a threshold risk, and
(ii) a second condition being satisfied, the second condition being that an operation amount of an acceleration operator of the host vehicle is equal to or greater than a threshold amount.

3. The driving assistance apparatus according to claim 2,
wherein the driving assistance apparatus is configured to:
execute driving assistance control for causing the host vehicle to travel either at a preset set vehicle speed or while maintaining an inter-vehicle distance between the host vehicle and a preceding vehicle traveling ahead of the host vehicle in a host lane in which the host vehicle is traveling at a preset set distance;
suspend the driving assistance control and cause the host vehicle to travel with a driving force corresponding to the operation amount in response to the second condition being satisfied during execution of the driving assistance control; and
determine that the non-recommendation condition is satisfied in response to the second condition being satisfied.

4. The driving assistance apparatus according to claim 1,
wherein the driving assistance device is configured to:
display, as the energy efficiency improvement image, in addition to the following recommendation image, an energy efficiency state image representing a current energy efficiency improvement level of the host vehicle, the energy efficiency improvement level being acquired based at least on the air resistance reduction effect of a preceding vehicle traveling ahead of the host vehicle in a host lane in which the host vehicle is traveling.

5. The driving assistance apparatus according to claim 1,
wherein the driving assistance apparatus is configured to acquire the air resistance reduction effect based at least on a projected area of a rear surface of another vehicle traveling ahead of the host vehicle.

6. The driving assistance apparatus according to claim 1,
wherein the driving assistance apparatus is configured to:
determine whether or not the host vehicle is able to change lanes to an adjacent lane adjacent to a host lane in which the host vehicle is traveling, in response to determining that an adjacent vehicle traveling ahead of the host vehicle in the adjacent lane is the recommended following vehicle; and
not display the following recommendation image for the adjacent vehicle in response to determining that the host vehicle is not able to change lanes to the adjacent lane.

7. The driving assistance apparatus according to claim 6,
wherein the driving assistance apparatus is configured to:
in response to determining that both
(i) a preceding vehicle traveling in a host lane in which the host vehicle is traveling and having the air resistance reduction effect equal to or greater than the predetermined value, and
(ii) an adjacent vehicle traveling in an adjacent lane adjacent to the host lane and having the air resistance reduction effect equal to or greater than the predetermined value
are present,
identify, as the recommended following vehicle, the one having a greater air resistance reduction effect.

8. The driving assistance apparatus according to claim 7,
wherein the driving assistance apparatus is configured to:
in response to determining that both
(i) the preceding vehicle traveling in the host lane in which the host vehicle is traveling and having the air resistance reduction effect equal to or greater than the predetermined value, and
(ii) the adjacent vehicle traveling in the adjacent lane adjacent to the host lane and having the air resistance reduction effect equal to or greater than the predetermined value
are present, and that the air resistance reduction effect of the adjacent vehicle is greater than that of the preceding vehicle,
determine whether or not the host vehicle is able to change lanes to the adjacent lane; and
in response to determining that the host vehicle is not able to change lanes to the adjacent lane,
identify the preceding vehicle having the air resistance reduction effect equal to or greater than the predetermined value as the recommended following vehicle, and
display the following recommendation image for the preceding vehicle.

9. A driving assistance method in which a computer mounted on a host vehicle displays, on a display device of the host vehicle, an energy efficiency improvement image for improving energy efficiency of the host vehicle,
the driving assistance method comprising:
displaying, by the computer, as the energy efficiency improvement image, a following recommendation image that recommends the host vehicle to follow behind a recommended following vehicle traveling ahead of the host vehicle and having an air resistance reduction effect, which reduces air resistance acting on the host vehicle, equal to or greater than a predetermined value; and
not displaying, by the computer, the following recommendation image in response to a non-recommendation condition being satisfied, the non-recommendation condition being a condition that is satisfied when a driving operation for following behind the recommended following vehicle is not recommended.

10. A non-transitory computer-readable storage medium storing a program for causing a computer mounted on a host vehicle to display, on a display device of the host vehicle, an energy efficiency improvement image for improving energy efficiency of the host vehicle,
the program causing the computer to execute:
displaying, as the energy efficiency improvement image, a following recommendation image that recommends the host vehicle to follow behind a recommended following vehicle traveling ahead of the host vehicle and having an air resistance reduction effect, which reduces air resistance acting on the host vehicle, equal to or greater than a predetermined value; and
not displaying the following recommendation image in response to a non-recommendation condition being satisfied, the non-recommendation condition being a condition that is satisfied when a driving operation for following behind the recommended following vehicle is not recommended.
